(19) United States
(12) Patent Application Publication
(10) Pub. No.: US 2013/0064141 A1
(43) Pub. Date: Mar. 14, 2013

(54) Hidden Call Redirection at Calling Party

(71) Applicant: Sergei Benyaminov, Flushing, NY (US)

(72) Inventor: Sergei Benyaminov, Flushing, NY (US)

(73) Assignee: RUSSTEL S.A. LTD, Flushing, NY (US)

(21) Appl. No.: 13/228,531

(22) Filed: Sep. 9, 2011

(51) Int. Cl. H04L 12/66; H04W 4/00

(52) U.S. Cl. 370/259; 370/352

(57) ABSTRACT

The disclosed technology allows a user to dial a phone number of a party to call or select a contact from a contact list, but have their device dial a different phone number. This different phone number costs less to dial than the phone number of the called party, and the number is unknown or unseen by the calling party, in embodiments of the disclosed technology. A data channel is used to relay the intercepted number and receive back a different number which the device actually dials over a regular telecommunications (PSTN) network.

### FIELD OF THE DISCLOSED TECHNOLOGY

The disclosed technology relates generally to call dialing, and more specifically to redirecting a calling device to dial a different number.

### BACKGROUND OF THE DISCLOSED TECHNOLOGY

It is known that calling rates are not uniform. A telecommunications provider may have one rate for “local” calls, another for in state calls, a third for out of state calls, and a fourth different rate for each country when dialing internationally. Still further, a rate may be different when calling a number within the same phone company versus a number provided by a different phone company. To get around higher charges, some carriers transfer the voice data over a voice over IP (internet protocol) network or other packet switched network where multiple streams of communication take place simultaneously over the same network by breaking up the data into packets, instead of sending it over a dedicated circuit. Thus, one might make a call using a service such as “Viber” www.net2phone.com), which allows one to place a call to a person, anywhere in the world, in this manner. Still further, voice-over IP telephone lines with associated phone numbers may be purchased from retailers such as Vonage (www.vonage.com) and ViaTalk (www.viatalk.com).

However, to bypass toll calling rates and use voice-over IP, typically, both the calling party and called party must be using voice-over IP and must connect via proprietary means. That is, one cannot pick up their voice-over IP phone and dial 1+country code+number and expect to be connected for free. Rather, even if both parties are using a voice-over IP phone line (one which provides a designated telephone number in the international PSTN (public switched telephone network), if the call is placed via the PSTN, the call is billed as any other international call.

One solution to this has been disclosed in U.S. Pat. No. 7,346,156 assigned to Stanacard LLC and hereby incorporated by reference in its entirety. In this method, a caller receives an assigned telephone number to call, and, based on CallerID (Caller identification which provides the number of a calling party to the called party), forwards the call via a voice-over IP network to a called party. In this manner, the calling party calls a local number for which it is either not charged, or charged a lesser rate, and an intermediary recognizes the caller and connects the caller to a different third party destination. The downside to this method is that a different intermediary number must be configured for each call which is to be forwarded, and this additional intermediary number must be stored, memorized, or written down. Further, such an intermediary number must be set up ahead of time and is setup separately for each phone line. For example, if a business has five phone lines and twenty international numbers called on a regular basis, this solution for making such international calls is extremely cumbersome to set up, the other alternative being to pay for an international calling plan or use proprietary solutions which may not be available. Still further, if a calling party dials many different international numbers, the system becomes even more unworkable.

What is needed in the art is a way to avoid changing user behavior in terms of use of the PSTN (the “regular” phone network) to make international or toll calls, but have the benefits of cheaper rates by using free or almost free networks to connect, such as by keeping all calls local and/or using voice-over IP to connect the parties.

### SUMMARY OF THE DISCLOSED TECHNOLOGY

The disclosed technology described herein addresses a need to keep the telephone system simple and as known to billions of users around the world, while allowing callers to avoid toll calling by redirecting calls to local numbers which are set up for each call. That is, a user dials a toll call as usual, but the dialing is intercepted, and via the data network for which the device connts to, a new number is provided to be dialed, which is then dialed automatically. This new local (or toll free) number connects users via next generation networks, such as voice-over IP (internet protocol) or another packet-switched network over part of the connection, such as until the last leg of the connection, when the telephone network is again used to connect the dialed number.

The technology may be carried out on a hand-held wireless device, in an embodiment of the disclosed technology. Such a device has telecommunications network connectivity via the public switched telephone network (PSTN), and data network connectivity via a packet -switched network (3G network, 4G network, or their successors), and a menu of contacts, each contact further comprising a phone number for dialing via the public switched telephone network. Upon a phone number being selected for dialing via the public switched telephone network, the selected phone number is transmitted via the data network to a third party. (Software on the phone may be configured to carry out the interception of a number dialed, determine if it is a long distance number or if the call is cheaper to place via the third party network, and then either dial the number as dialed, or dial a different number, as explained below.) A second phone number is received from the third party, in embodiments of the disclosed technology, and the hand-held wireless device dials the second phone number via the public switched telephone network, and the hand-held wireless device is connected via the telecommunications network with a called party associated with the selected phone number. Such a method may also be carried out on a private branch exchange (PBX) for many possible outgoing phone calls, such that outgoing phone calls are re-routed to local phone numbers which are configured, on the fly, to connect to the number dialed by the user. With either a PBX or handheld-wireless device, the second phone number (the one actually dialed) may be hidden from a user who selected the final destination number.

If an account balance of an owner of the hand-held wireless device is below a threshold, the device may receive data via the packet-switched network prompting the user to add funds to the account before the device dials the second phone number. An interactive voice response system (IVR) may be used to carry out this feature or other features, such as an identifier of the third party or account balance. The IVR may also allow the user to add funds to his/her account.

In a method of connecting a calling party to a called party via an intermediary party, in embodiments of the disclosed technology, an attempt to dial a party to be called is intercepted on a calling device. Via a packet-switched data network, a phone number of the party to be called is sent along with identifying information of the calling device to a third party intermediary. A second phone number to dial is received from the third party intermediary via the packet switched data network, which is dialed. Voice data is then transmitted and received between the calling party and the called party via a combination of circuit-switched and packet-switched network connections.

In the above embodiment, the called party may be in a different country from the calling party, and the second phone number may be in the country of the calling party.

A method of configuring call routing, in an embodiment of the disclosed technology, proceeds by receiving via a packet-switched network a first phone number and an identifier of a device sending the phone number, determining an account associated with the device, and determining a geographic location of the device (such as provided with the user billing address, the area code, or GPS (global positioning system) data. A second number to dial is then provided to the device via the packet-switched data network. Then, a call is received to the second number from the device via a telecommunications network, where the call is identified as being from the device, and the device is then connected to a called party associated with the first number via voice over IP (a packet-switched network).

The identifying may be based on CallerlD data and/or on a difference in time below a predesignated threshold between the providing of the second number and receiving a call to the second number. As such, the second number may be provided to a plurality of devices in succession, and, depending on which device is calling in, as identified by CallerlD or time, the destination number to which a device is connected to, is different.

The step of connecting may only be carried out, limited to, if sufficient funds are in an account associated with the device. Further, the providing of the second number may also be sent with instructions understood by the (calling) device to cause immediate dialing of the second number via the telecommunications network. As such, the calling of a second number, instead of the one selected by a user, may be seamless. With the small window of time, such as less than three seconds between providing the number and receiving the call to the second number, the calling device may be verified. This time frame, such as within three seconds, may be required, as it is the maximum time between dialing the second of the number and the anticipated receipt of the phone call to the second number. It may also be verified by exchanging time data over the packet-switched network, such as call times and connect times. As such, the times might be less than one second difference to properly match the packet-switched data connection to the device with the circuit-switched (regular phone) connection and connecting the call properly.

A combination circuit-switched system and packet-switched system is also claimed. Such a system has means for receiving a destination phone number via the packet-switched system, means for identifying the device sending the destination phone number, means for associating the device with a user account and verifying that the user account is funded, means for providing an intermediary phone number to the device via the packet-switched system, means for receiving a call to the intermediary phone number and determining that the call is from the proper device, and means for connecting the received call to the destination phone number via a device associated with the intermediary phone number.

The means for associating the device with the user account may include callerID and/or measurement of time between the providing of the intermediary phone number and the receiving of the call to the intermediary phone number. An interactive voice response system (IVR) may also be utilized. A connection between the device sending the destination phone number (calling party) and the device associated with the intermediary phone number is circuit-switched, in an embodiment of the disclosed technology, while a connection between the device associated with the intermediary phone number and a device associated with the destination phone number has a circuit-switched leg and a packet-switched leg. The circuit-switched leg may terminate at the device associated with the destination phone number.

### BRIEF DESCRIPTION OF THE DRAWINGS

FIG. 1 shows a high level diagram of devices used in embodiments of the disclosed technology.

FIG. 2 shows an event chain diagram of steps carried out between high level devices of the disclosed technology.

FIG. 3 shows a flow chart of steps taken by an intermediary party or combined phone and network switch or system of embodiments of the disclosed technology.

FIG. 4 shows a high level example of carrying out methods of the disclosed technology using devices of the disclosed technology.

FIG. 5 shows a high-level block diagram of a device that may be used to carry out the disclosed technology.

### DETAILED DESCRIPTION OF EMBODIMENTS OF THE DISCLOSED TECHNOLOGY

The disclosed technology allows a user to dial a phone number of a party to call or select a contact from a contact list, but to have the user's device dial a different phone number. This different phone number costs less to dial than the phone number of the called party, and the number is unknown or unseen by the calling party, in embodiments of the disclosed technology. A data channel is used to relay the intercepted number and receive back a different number, which the device actually dials over a regular telecommunications (PSTN) network.

Embodiments of the disclosed technology will become clearer in view of the following description of the figures.

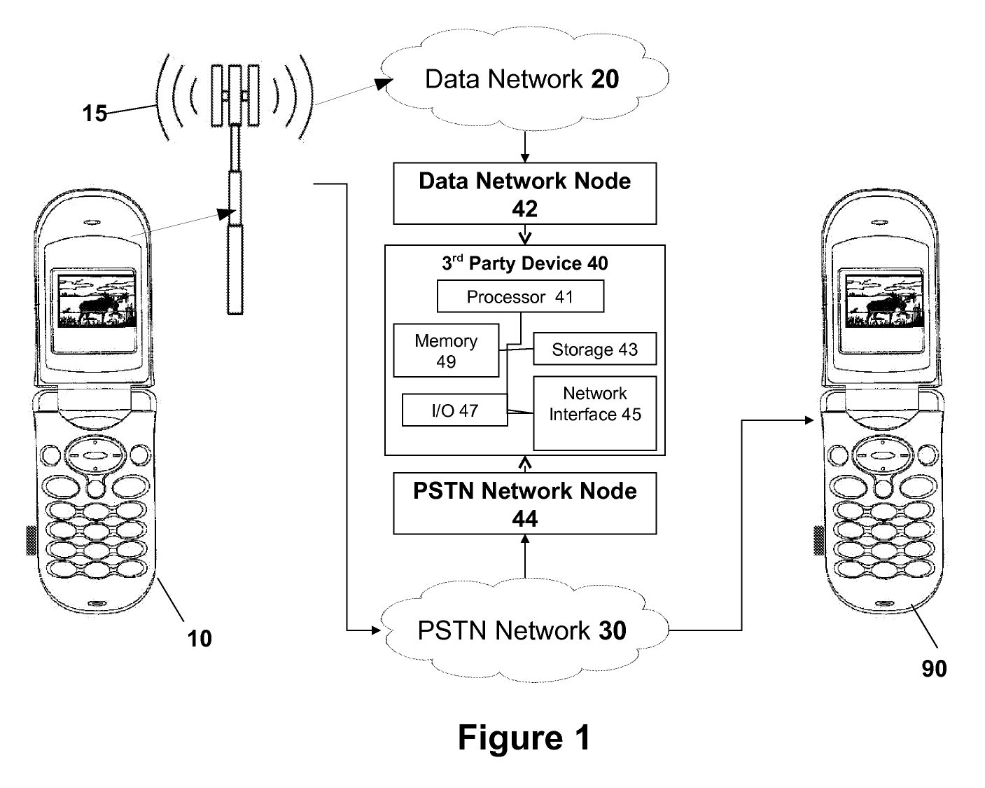

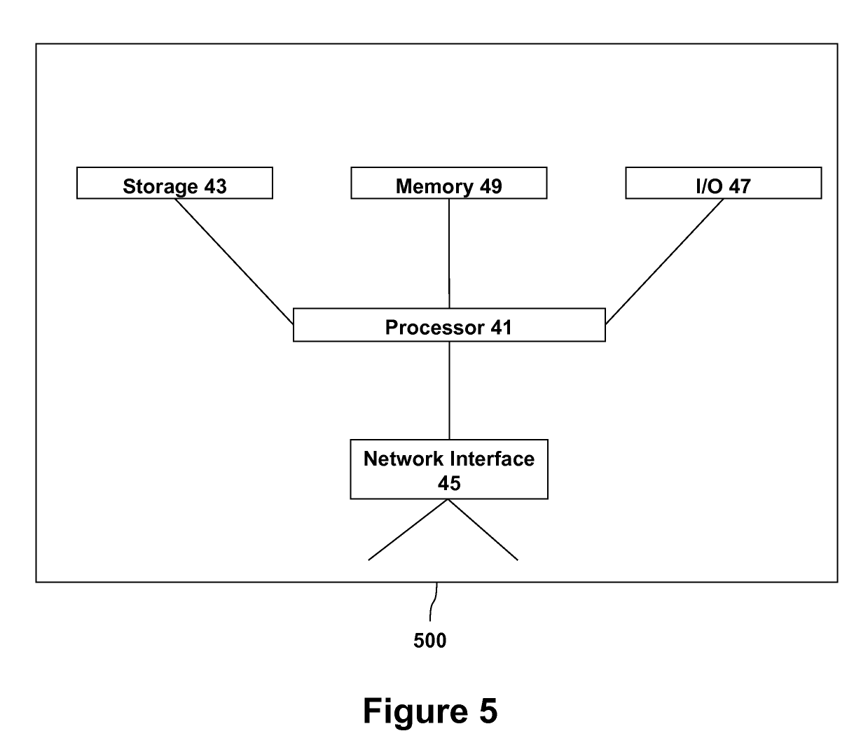

FIG. 1 shows a high level diagram of devices used in embodiments of the disclosed technology. Hand-held device 10 is a device with two types of network connectivity: data network connectivity 20 and telecom (or PSTN) network connectivity 30. Data network connectivity is defined as a packet-switched designed for sending and receiving packets of encoded IP (internet protocol) traffic or equivalents thereof. Telecom network connectivity is defined as connectivity to the public switched telephone network where calls are made via assigned phone numbers. This connectivity comprises, at least in part, a circuit-switched network (defined as a persistent electrical connection between two nodes in the network). The hand-held wireless device connects wirelessly to the networks 20 and 30 via a network node, such as a cellular tower 15. A third-party device 40 communicates to the hand-held device 10 via both the data and PSTN networks 20 and 30. A data network node 42 sends and receives data from the device 40 to the data network 20, and a PSTN network node 44 receives phone calls from, and makes phone calls to, the device 40 to the PSTN network 30. In this manner, calls may be made to a called party 90, or otherwise described as a device associated with the phone number selected for calling by the calling party, using the calling device 10. The processor 41, memory 49, I/O (input/output) 47, storage 43, and network interface of the third party device 40 are analogous to same-named devices of FIG. 5, the description of these devices provided below with respect to this later figure. Further, it should be understood that the third party device may be a single device or a plurality of devices in a system, working in conjunction to carry out the features described in this disclosure.

At a high level, a user uses calling device 10 to dial or select a number (used interchangeably in this disclosure and defined as selecting from a contact list or other menu a number to call, a contact to call having a phone number associated therewith, and/or typing in a number on a keypad to arrange dialing thereof). The number of the called party is sent via a data network 20 to the third party device 40 via data network node 42. This device checks the number, identifies the calling device 10 and account associated therewith, and may provide an IVR, as well as other functions described in greater detail in later figures, and returns a number to call to the device 10 via the data network 20 with instructions to call the second number. The device then automatically places a call to this second number via the PSTN network 30 upon receiving the second number with instructions understood by the calling device 10 to signify that the calling device should call the number. The call is received at the PSTN network node 44 (as it is a phone number associated with the third party). The third party verifies the caller, and forwards the call through one or more networks, such as via a voice-over IP (internet protocol) or packet-switched network) until the call exits back out the PSTN network 30, such as at the last leg of the call, and becomes circuit-switched near the called party 90. The circuit is then completed to the called party 90 from the calling party 10, the call at the calling and called devices being over the telecommunications network.

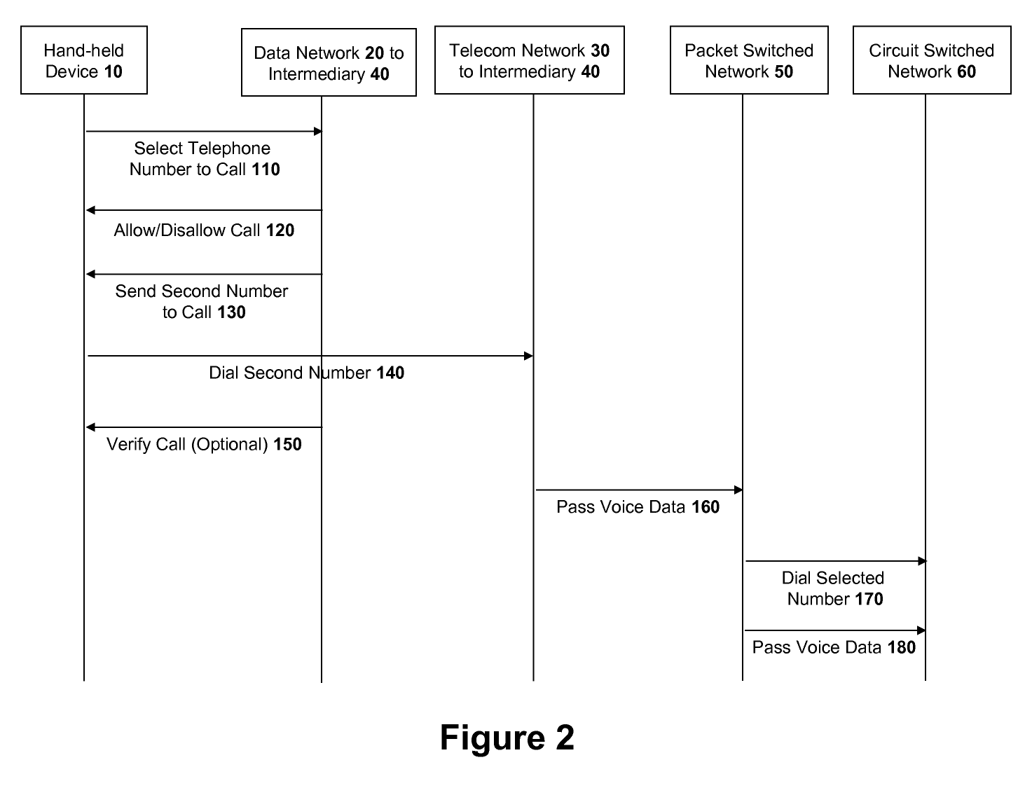

FIG. 2 shows an event chain diagram of steps carried out between high level devices of the disclosed technology. On the hand-held device 10, a telephone number is selected for calling in step 110 (see definition in the description of FIG. 1). This is carried out via the data network 20 to the intermediary 40, which then checks if the hand-held device 10 has a registered account, whether the account is funded or has a functioning funding source which can be debited, and, in some cases, if the intermediary can place the call at a less expensive rate than if the hand-held device 10 makes the call directly to the called party over the telecommunications network. These eventualities will be discussed further with respect to the flow charts, but for purposes of this figure, in step 120, it is decided whether the call will be allowed or disallowed via the intermediary. If the call is allowed, a second phone number to call is sent to the hand-held device in step 130. Upon receipt, and without further control by the user of the hand-held device 10, the hand-held device dials this second number 140 making the first actual connection between the hand-held device and the telecommunications network 30. The second number called goes to the intermediary 40, where the call is received and verified. Verification that the call has originated from the hand-held device 10 may be via checking CallerlD data (caller identification/calling line identification, as known in the art), ANI (automatic number identification, as known in the art), and/or that the call is received proximate in time to step 130, such as within three seconds or one second of step 130 being completed. Verification, in some embodiments is limited to time and may further be done, as shown in step 150, by additional communications over the data network 20 between the hand-held device and intermediary 40. In this manner, information such as time of call, time of receipt of call, present time according to each device, latency (for purposes of ensuring that the time stamps exchanged can be reconciled), and number dialed may be exchanged. In this manner, if someone else were to call into the second number at the same time, using a different device, the call would not be sent to the called party because the hand-held device 10 would not indicate to the intermediary 40 that it is on the telecommunications line via the second number.

Once it is determined that the hand-held device 10 is connected to intermediary 40 via the telecommunications network, using the second number assigned for calling in step 130, then the intermediary proceeds to connect the calling party/hand-held device 10 to the called party. Voice data is passed to a packet switched network 50 (such as the collection of switches, hubs, and nodes with assigned Internet protocol (IP) addresses known as “the Internet”) to a geographic destination proximate to the called party (who, at this time, is the party intended to be the called party). There, the voice data may be forwarded to a circuit-switched network 60 by dialing the selected number. That is, the number selected by the calling party on the hand-held device 10 is dialed. For purposes of this disclosure, changing prefixes, country codes, and regional dialing codes from those the user selected to what is actually dialed is within the scope of what is defined as “dialing the number the user selected.” Voice data is then passed to the circuit-switched network in step 180, and the hand-held device 10 is in voice communication with the called party 90.

Steps 160 through 180 may take place automatically immediately after step 130, without waiting for steps 140 and 150 to complete. In this manner, any time lost due to carrying out steps 110 to 130, which are additional compared to traditional dialing, is made up by proceeding to connect the downward legs of the call which may be time consuming, such as when calling internationally. Further, it should be understood that when either party terminates the call (that is, terminates a circuit-switched leg at the calling party 10 or called part 10 or hangs up the phone), then this has the cascading effect to disconnect the other legs. Still further, it should be understood that the second number 140 may be reused repeatedly for new calls, in succession, by the same hand-held device or by a different device. Based on time, CallerID, or other methods of verification described herein, it can be determined which device 10 is calling via the telecommunications network and where the call should be sent. It is contemplated that a single phone number can be used to process up to 30, 60, or 100 calls per minute. Compared to the prior art, which requires a ratio of one number to dial-in per one number to dial-out per user, this is a great savings as a number can be recycled over and over for each call, instead of just each user.

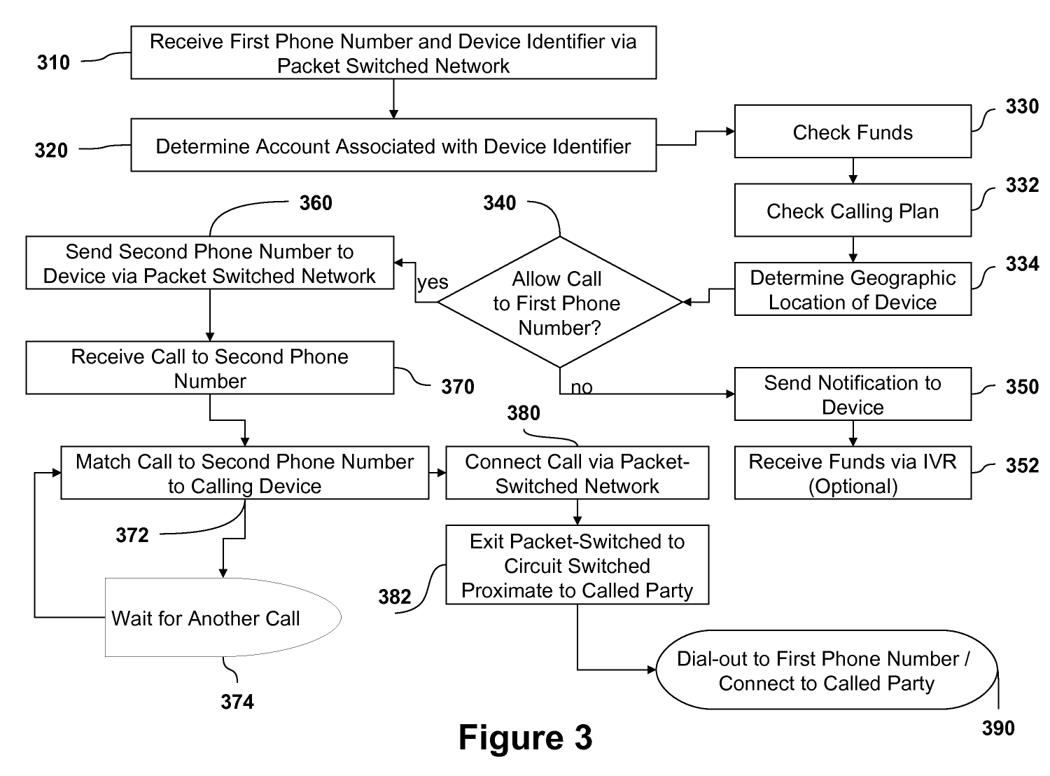

FIG. 3 shows a flow chart of steps taken by an intermediary party or combined phone and network switch or system of embodiments of the disclosed technology. In step 310, a first phone number and device identifier are received via a packet-switched network (such as the Internet). These data are received through a data network connection, such as via data network 20 and data network node 42 (see FIG. 1). The device identifier might be a phone number, serial number, account number, username, or other credentials used to identify a device, or account and device, of the calling party with the intermediary. Based on this information, in step 320, it is determined which account is associated with the device identifier. Using these data, any one of steps 330, 332, and 334 may be carried out, whereby the amount of funds available is checked in step 330. This may include checking prepaid funds on hand, checking that the user account balance is not overdue more than a designated time frame, and so forth. The calling plan, in step 332, may also be checked. If the first phone number (defined as the number that the calling party wants to connect to) is in India, for example, and the calling plan only allows calls to go to the United States and Israel, then the call would not be allowed to go through. In step 334, the geographic location of the device is determined, if this step is carried out. Determination of the geographic location may be carried out via GPS (global positioning system), CallerID data, billing address, or other methods known in the art. This may also be done in conjunction with comparing the call cost for the calling party using the intermediary, versus dialing through the PSTN system to the called party (defined as the party the calling party intends to connect with and talk to, and associated with the first phone number; other than any IVR or the like of the intermediary).

If any conditions, determined in steps 330, 332, or 334, are not properly met, then in step 340, the call to the first phone number is disallowed. A notification may be sent to the device of the calling party in step 350, which may be via a data network or the telecommunications network (by voice). If the call has been disallowed due to lack of funds, then funds may be sent via an IVR system in step 352 (e.g., authorization to bill a credit card on file or enter a new credit card number using an IVR) and then the call may be placed. Similarly, an IVR may be used, in all instances or only when a call is denied, to check account balance, account usage, change the phone plan, announce that the call is being sent through the intermediary, or the price per minute for the call.

In step 340, if the call is allowed to proceed to the first phone number, then step 360 is carried out. In step 360, a second phone number is sent to the device of the calling party via the packet-switched network (such as via the data connection path used to receive the first phone number, which may be, for example, a 3G or 4G network or their equivalents, or even via SMS (short message service). The receiving device (of the calling party) interprets this receipt of a second phone number as instructions to call the number. For security, the device may only call the number at the behest of the user sending out the first number and receiving back the second number within a predetermined time period, and/or with a security code (such as via a Diffie-Hellman key exchange during the sending of the first number and receipt of the second), such that the security code changes for each call. The device of the calling party then dials the second number which is received in step 370, the second number associated with the intermediary.

The intermediary then recognizes the calling party, such as based on the time frame, CallerID, verification over the data channel, or the like, as described with reference to FIG. 1. This step of matching the call to the second number to the calling device takes place in step 372. In step 374, another call is expected. Multiple calls from different devices/calling parties may come in to the same second phone number and must be routed appropriately.

Once the call is received and matched properly, the call is connected via a packet-switched network in step 380. That is, the call is received by a circuit-switched network from the calling party to the intermediary, who then connects the call, such as via voice-over IP, or using an internet protocol (IP) where it exits the packet-switched network, in step 382, to a circuit-switched network proximate to the called party. “Proximate” is defined as in the same country as the called party, or where the calling rates to the called party are least expensive. In rare cases, the two definitions of proximate do not coincide, such as when local calling is actually higher than longer distance calling. In some cases, it is cheaper to call out of state than in state in the United States, and in some countries, such as parts of Italy, it is cheaper to call the country from a remote country than it is from a neighboring region. Finally, in step 390, the intermediary or its designee connects to the first phone number to connect to the called party. This may be via circuit-switched network and/or on the PSTN.

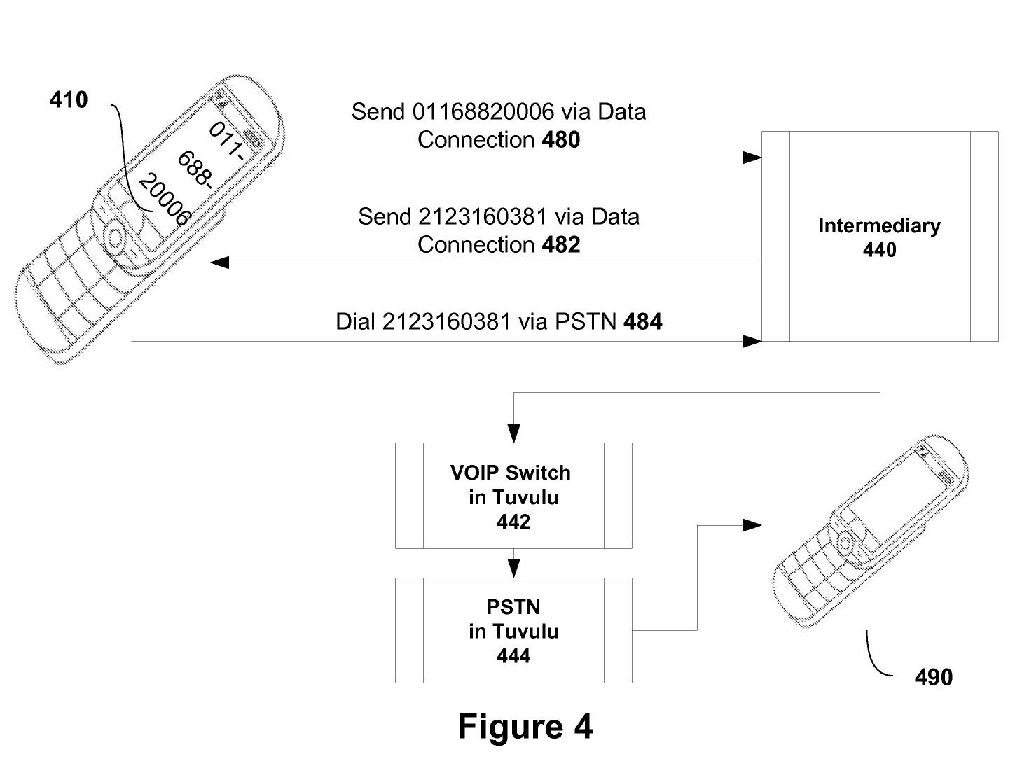

FIG. 4 shows a high level example of carrying out methods of the disclosed technology using devices of the disclosed technology. On calling device 410, a number is selected for dialing, in this instance, 011-688-20006 which corresponds to directory assistance on the Tuvalu islands [Calling rates from the United States are typically between $1 and $5 per minute at the time of this writing.] This number is sent via a data connection in step 480 to an intermediary 440 which receives the number, and sends back to the calling device 410 the number 212-3160381, which is a local dial-in access number in step 442. Without prompting the user of the calling device, the device, instead of dialing the first number, as selected by the user, dials this second number in step 484. A telephone call is placed to 212-3160381, where it is again picked up by the intermediary 440, which recognizes this incoming call as being from the device 410, and connects the call via voice-over IP (VOIP) to a data network switch (on a packet-switched network) 442 in Tuvalu. From there, as calls dialed via the PSTN cannot typically be connected off network, the call is sent to the PSTN 444 where the call is placed to the recipient device 490, associated with the 011-688-20006 telephone number.

FIG. 5 shows a high-level block diagram of a device that may be used to carry out the disclosed technology. Device 500 comprises a processor 41 that controls the overall operation of the computer by executing the device's program instructions which define such operation. The device's program instructions may be stored in a storage device 43 (e.g., magnetic disk, database) and loaded into memory 49 when execution of the program instructions is desired. Thus, the device's operation will be defined by the device's program instructions stored in memory 49 and/or storage 43, and the console will be controlled by processor 41 executing the console's program instructions. A device 500 also includes one, or a plurality of, input network interfaces for communicating with other devices via a network (e.g., the internet). The device 500 further includes an electrical input interface. A device 500 also includes one or more output network interfaces 45 for communicating with other devices. Device 500 also includes input/output 47 representing devices which allow for user interaction with a computer (e.g., display, keyboard, mouse, speakers, buttons, etc.). One skilled in the art will recognize that an implementation of an actual device will contain other components as well, and that FIG. 6 is a high level representation of some of the components of such a device for illustrative purposes. It should also be understood by one skilled in the art that the method and devices depicted in FIGS. 1 through 4 may be implemented on a device such as is shown in FIG. 5.

Referring to FIGS. 1 through 5 in general, it should be understood that device 10, a private branch exchange (PBX), or any other device which carries out aspects of embodiments of the disclosed technology, may have a configuration script or series of instructions which are carried out upon selecting a telephone number, such as a telephone number 110. The selection may be a selection to dial the number, a select of a contact in a contact list, or a selection of a telephone number with the specific intent to send it via a data connection to an intermediary, such as to a 3^{rd} party device 40 or another control device. A “software application”, defined as coded instructions understood by a dialing device (handheld wireless device, PBX system, or other device capable of dialing via the PSTN) may comprise such instructions which are executed by a processor 41 and cause a dialing device to intercept a dialed or selected number, and send the number through a data connection, wait for a received second number, and instead, dial this second number.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described herein-above are also contemplated and within the scope of the disclosed technology.

I claim:

1. A hand-held wireless device, comprising:
telecommunications network connectivity via the public-switched telephone network, data network connectivity via a packet-switched network, and a menu of contacts, each contact further comprising a phone number for dialing via said public-switched telephone network; wherein:
upon a said phone number being selected for said dialing via said public-switched telephone network, said selected phone number is transmitted via said data network to a third party;
a second phone number is received from said third party;
said hand-held wireless device dials said second phone number via said public-switched telephone network; and
said hand-held wireless device is connected via said telecommunications network with a called party associated with said selected said phone number.

2. The hand-held wireless device of claim 1, wherein said second phone number dialed is hidden from a user of said hand-held wireless device.

3. The hand-held wireless device of claim 1, wherein if an account balance of an owner of said hand-held wireless device is below a threshold, said device receives data via said packet-switched network prompting the user to add funds to said account before said device dials said second phone number.

4. The hand-held wireless device of claim 1, wherein, after said device dials said second phone number and before said hand-held wireless device is connected to a called party, an interactive voice response system is provided with a menu of options.

5. The hand-held wireless device of claim 4, wherein said menu of options includes an option to add funds to an account.

6. A method of connecting a calling party to a called party via an intermediary party, comprising:
intercepting an attempt to dial a party to be called on a calling device;
sending, via a packet-switched data network, a phone number of said party to be called and identifying information of said calling device to a third party intermediary;
receiving a second phone number to dial from said third party intermediary via said packet-switched data network;
dialing said second phone number on a telecommunications network;
transmitting and receiving voice data between said calling party and said called party via a combination of circuit-switched and packet-switched network connections.

7. The method of claim 6, wherein said called party is in a different country than said calling party, and said second phone number is in a country of said calling party.

8. A method of configuring call routing, comprising:
receiving via a packet-switched network a first phone number and an identifier of a device sending said phone number;
determining an account associated with said device;
determining a geographic location of said device;
providing a second number to dial to said device via said packet-switched data network;
receiving a call to said second number from said device via a telecommunications network;
identifying said received call as being from said device;
connecting said device to a called party associated with said first number via voice-over IP.

9. The method of claim 8, wherein said identifying is based on CallerlD data.

10. The method of claim 9, wherein said identifying is based on a difference in time below a predesignated threshold between said providing of said second number and said receiving a call to said second number.

11. The method of claim 10, wherein said second number is provided to a plurality of devices in succession.

12. The method of claim 8, wherein said step of connecting is carried out only if sufficient funds are in an account associated with said device.

13. The method of claim 8, wherein, with said providing of said second number, instructions are sent which are understood by the device to cause immediate dialing of said second number via said telecommunications network.

14. The method of claim 13, wherein, after providing said second number to said device, call dialing and connection times are received via said packet-switched network from said device and compared to call receipt times at a device associated with said second number; and
said connecting is carried out only if said time information is below a threshold of three seconds.

15. A combination circuit-switched system and packet-switched system, comprising:
means for receiving a destination phone number via said packet-switched system;
means for identifying a device sending said destination phone number;
means for associating said device with a user account and verifying that said user account is funded;
means for providing an intermediary phone number to said device via said packet-switched system;
means for receiving a call to said intermediary phone number and determining that said call is from said device;
means for connecting said received call to said destination phone number via a device associated with said intermediary phone number.

16. The system of claim 15, wherein said means for associating said device with said user account include the user of CallerID.

17. The system of claim 15, wherein said means for associating said device with said user account include measurement of time between said providing of said intermediary phone number and said receiving of said call to said intermediary phone number.

18. The system of claim 15, further comprising an interactive voice response system.

19. The system of claim 15, wherein a connection between said device sending said destination phone number and said device associated with said intermediary phone number is circuit-switched; and
a connection between said device associated with said intermediary phone number and a device associated with said destination phone number comprises a circuit-switched leg and a packet-switched leg.

20. The system of claim 19, wherein said circuit-switched leg terminates at said device associated with said destination phone number.
